(19) United States
(12) Patent Application Publication
(10) Pub. No.: US 2026/0261674 A1
(43) Pub. Date: Sep. 3, 2026

(54) Methods and Systems for High Bit Depth and High Dynamic Range Image Compression

(71) Applicant: Google LLC, Mountain View, CA (US)

(72) Inventors: Jyrki Alakuijala, Wollerau, Schwyz (CH); Luca Versari, Zürich (CH)

(21) Appl. No.: 18/846,529

(22) PCT Filed: Mar. 15, 2022
(86) PCT No.: PCT/US2022/071167

§ 371 Date: Sep. 12, 2024

(51) Int. Cl. H04N 19/124; H04N 19/132; H04N 19/136; H04N 19/184; H04N 19/186; H04N 19/625

(52) U.S. Cl. CPC H04N 19/124; H04N 19/132; H04N 19/136; H04N 19/184; H04N 19/186; H04N 19/625

(57) ABSTRACT

An example method includes receiving, in a frame buffer of a computing device, an image captured by an image capturing device of the computing device. The image comprises a first number of bits. The method includes applying, based on the first number of bits, a linear transform to the received image. The linear transform comprises: (i) a color transform, and (ii) a discrete cosine transform (DCT), to generate a frequency spectrum comprising one or more frequency components. The method includes quantizing respective amplitudes of the one or more frequency components. A number of quantization steps to be applied is configured to reduce error in the one or more frequency components. The method includes generating, by an image processor and based on the quantizing, a compressed image comprising a second number of bits. The second number of bits is larger than a bit capacity for compression associated with the image processor.

### BACKGROUND

Many modern computing devices, including mobile phones, personal computers, and tablets, include image capture devices, such as still and/or video cameras. The image capture devices can capture images, such as images that include people, animals, landscapes, and/or objects. The images may be encoded, saved and/or transmitted in an encoded format. The images may be received in an encoded format over a network, decoded, and displayed by a display panel of a computing device.

### SUMMARY

In one aspect, a computing device may be configured to store high bit depth and high dynamic range images.

In a first aspect, a computer-implemented method is provided. The method includes receiving, in a frame buffer of a computing device, an image captured by an image capturing device of the computing device, wherein the image comprises a first number of bits. The method includes applying, based on the first number of bits, a linear transform to the received image, wherein the linear transform comprises: (i) a color transform, and (ii) a discrete cosine transform (DCT), to generate a frequency spectrum comprising one or more frequency components. The method includes quantizing respective amplitudes of the one or more frequency components, wherein a number of quantization steps to be applied is configured to reduce error in the one or more frequency components. The method includes generating, by an image processor and based on the quantizing, a compressed image comprising a second number of bits, wherein the second number of bits is larger than a bit capacity for compression associated with the image processor.

In a second aspect, a system is provided. The system may include one or more processors. The system may also include data storage, where the data storage has stored thereon computer-executable instructions that, when executed by the one or more processors, cause the system to carry out operations. The operations may include receiving, in a frame buffer of a computing device, an image captured by an image capturing device of the computing device, wherein the image comprises a first number of bits. The operations may further include applying, based on the first number of bits, a linear transform to the received image, wherein the linear transform comprises: (i) a color transform, and (ii) a discrete cosine transform (DCT), to generate a frequency spectrum comprising one or more frequency components. The operations may also include quantizing respective amplitudes of the one or more frequency components, wherein a number of quantization steps to be applied is configured to reduce error in the one or more frequency components. The operations may additionally include generating, by an image processor and based on the quantizing, a compressed image comprising a second number of bits, wherein the second number of bits is larger than a bit capacity for compression associated with the image processor.

In a third aspect, a device is provided. The device includes one or more processors operable to perform operations. The operations may include receiving, in a frame buffer of a computing device, an image captured by an image capturing device of the computing device, wherein the image comprises a first number of bits. The operations may further include applying, based on the first number of bits, a linear transform to the received image, wherein the linear transform comprises: (i) a color transform, and (ii) a discrete cosine transform (DCT), to generate a frequency spectrum comprising one or more frequency components. The operations may also include quantizing respective amplitudes of the one or more frequency components, wherein a number of quantization steps to be applied is configured to reduce error in the one or more frequency components. The operations may additionally include generating, by an image processor and based on the quantizing, a compressed image comprising a second number of bits, wherein the second number of bits is larger than a bit capacity for compression associated with the image processor.

In a fourth aspect, an article of manufacture is provided. The article of manufacture may include a non-transitory computer-readable medium having stored thereon program instructions that, upon execution by one or more processors of a computing device, cause the computing device to carry out operations. The operations may include receiving, in a frame buffer of a computing device, an image captured by an image capturing device of the computing device, wherein the image comprises a first number of bits. The operations may further include applying, based on the first number of bits, a linear transform to the received image, wherein the linear transform comprises: (i) a color transform, and (ii) a discrete cosine transform (DCT), to generate a frequency spectrum comprising one or more frequency components. The operations may also include quantizing respective amplitudes of the one or more frequency components, wherein a number of quantization steps to be applied is configured to reduce error in the one or more frequency components. The operations may additionally include generating, by an image processor and based on the quantizing, a compressed image comprising a second number of bits, wherein the second number of bits is larger than a bit capacity for compression associated with the image processor.

In a fifth aspect, a computer-implemented method is provided. The method may include receiving, in a frame buffer of a computing device, an image captured by an image capturing device of the computing device, wherein the image comprises a first number of bits. The method may further include dequantizing respective amplitudes of one or more frequency components, wherein the dequantizing is based on an inverse of a quantization matrix compatible with a high dynamic range (HDR) image format, and wherein a number of dequantization steps to be applied is configured to reduce error in the one or more frequency components. The method may also include applying, based on the first number of bits, an inverse linear transform to the received image, wherein the inverse linear transform comprises: (i) an inverse color transform, and (ii) an inverse discrete cosine transform (DCT). The method may also include generating, by an image processor and based on the applying of the inverse linear transform, a decompressed image comprising a second number of bits, wherein the second number of bits is larger than a bit capacity for compression associated with the image processor. The method may additionally include providing the decompressed image via a display panel of the computing device.

In a sixth aspect, a system is provided. The system may include one or more processors. The system may also include data storage, where the data storage has stored thereon computer-executable instructions that, when executed by the one or more processors, cause the system to carry out operations. The operations may include receiving, in a frame buffer of a computing device, an image captured by an image capturing device of the computing device, wherein the image comprises a first number of bits. The operations may further include dequantizing respective amplitudes of one or more frequency components, wherein the dequantizing is based on an inverse of a quantization matrix compatible with a high dynamic range (HDR) image format, and wherein a number of dequantization steps to be applied is configured to reduce error in the one or more frequency components. The operations may also include applying, based on the first number of bits, an inverse linear transform to the received image, wherein the inverse linear transform comprises: (i) an inverse color transform, and (ii) an inverse discrete cosine transform (DCT). The operations may also include generating, by an image processor and based on the applying of the inverse linear transform, a decompressed image comprising a second number of bits, wherein the second number of bits is larger than a bit capacity for compression associated with the image processor. The operations may additionally include providing the decompressed image via a display panel of the computing device.

In a seventh aspect, a device is provided. The device includes one or more processors operable to perform operations. The operations may include receiving, in a frame buffer of a computing device, an image captured by an image capturing device of the computing device, wherein the image comprises a first number of bits. The operations may further include dequantizing respective amplitudes of one or more frequency components, wherein the dequantizing is based on an inverse of a quantization matrix compatible with a high dynamic range (HDR) image format, and wherein a number of dequantization steps to be applied is configured to reduce error in the one or more frequency components. The operations may also include applying, based on the first number of bits, an inverse linear transform to the received image, wherein the inverse linear transform comprises: (i) an inverse color transform, and (ii) an inverse discrete cosine transform (DCT). The operations may also include generating, by an image processor and based on the applying of the inverse linear transform, a decompressed image comprising a second number of bits, wherein the second number of bits is larger than a bit capacity for compression associated with the image processor. The operations may additionally include providing the decompressed image via a display panel of the computing device.

In an eighth aspect, an article of manufacture is provided. The article of manufacture may include a non-transitory computer-readable medium having stored thereon program instructions that, upon execution by one or more processors of a computing device, cause the computing device to carry out operations. The operations may include receiving, in a frame buffer of a computing device, an image captured by an image capturing device of the computing device, wherein the image comprises a first number of bits. The operations may further include dequantizing respective amplitudes of one or more frequency components, wherein the dequantizing is based on an inverse of a quantization matrix compatible with a high dynamic range (HDR) image format, and wherein a number of dequantization steps to be applied is configured to reduce error in the one or more frequency components. The operations may also include applying, based on the first number of bits, an inverse linear transform to the received image, wherein the inverse linear transform comprises: (i) an inverse color transform, and (ii) an inverse discrete cosine transform (DCT). The operations may also include generating, by an image processor and based on the applying of the inverse linear transform, a decompressed image comprising a second number of bits, wherein the second number of bits is larger than a bit capacity for compression associated with the image processor. The operations may additionally include providing the decompressed image via a display panel of the computing device.

Other aspects, embodiments, and embodiments will become apparent to those of ordinary skill in the art by reading the following detailed description, with reference where appropriate to the accompanying drawings.

### BRIEF DESCRIPTION OF THE FIGURES

FIG. 1 illustrates a computing device, in accordance with example embodiments.

FIG. 2 illustrates an example image encoder, in accordance with example embodiments.

FIG. 3 illustrates an example image decoder, in accordance with example embodiments.

FIG. 4 illustrates an image compression method, in accordance with example embodiments.

FIG. 5 illustrates an image decompression method, in accordance with example embodiments.

### DETAILED DESCRIPTION

Example methods, devices, and systems are described herein. It should be understood that the words “example” and “exemplary” are used herein to mean “serving as an example, instance, or illustration.” Any embodiment or feature described herein as being an “example” or “exemplary” is not necessarily to be construed as preferred or advantageous over other embodiments or features. Other embodiments can be utilized, and other changes can be made, without departing from the scope of the subject matter presented herein.

Thus, the example embodiments described herein are not meant to be limiting. Aspects of the present disclosure, as generally described herein, and illustrated in the figures, can be arranged, substituted, combined, separated, and designed in a wide variety of different configurations, all of which are contemplated herein.

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment.

### I. Overview

As image capture devices, such as cameras, become more popular, they may be employed as standalone hardware devices or integrated into various other types of devices. For instance, still and video cameras are now regularly included in wireless communication devices (e.g., mobile phones), tablet computers, laptop computers, video game interfaces, home automation devices, and even automobiles and other types of vehicles.

Captured digital images may be represented as a one-dimensional, two-dimensional, or multi-dimensional array of pixels. Each pixel may be represented by one or more values that may encode the respective pixel's color and/or brightness. For example, one possible encoding uses the YCbCr color model. In this color model, the Y channel may represent the brightness of a pixel, and the Cb and Cr channels may represent the blue chrominance and red chrominance, respectively, of the pixel. For instance, each of these channels may take values from 0 to 255 (i.e., the tonal range that a single 8-bit byte can offer). Thus, the brightness of a pixel may be represented by a 0 or a value near zero if the pixel is black or close to black, and by a 255 or a value near 255 if the pixel is white or close to white.

The YCbCr color model is just one possible color model, and other color models such as a red-green-blue (RGB) color model or a cyan-magenta-yellow-key (CMYK) may be employed with the embodiments herein. Further, the pixels in an image may be represented in various file formats, including raw (uncompressed) formats, or compressed formats such as Joint Photographic Experts Group (JPEG), Portable Network Graphics (PNG), Graphics Interchange Format (GIF), and so on.

Some pixel encodings—including the YCbCr color model—use 8 bits to represent the brightness of each pixel. Doing so is referred to as LDR imaging. As a result, only 256 levels of brightness may be supported. However, real-world scenes often exhibit a wider dynamic range of brightness than can be reasonably represented by LDR imaging. For example, a scene of an individual standing in a dark room in front of a window may include both extremely bright regions and extremely dark regions. However, use of LDR imaging to encode an image of such a scene may result in loss of detail in the bright region and/or the dark region. High dynamic range (HDR) imaging has been proposed as a way of compensating for the deficiencies of LDR imaging.

This application relates to an imaging system that extends a legacy Joint Photographic Experts Group (JPEG) format capacity to store an image captured by a camera with a given bit depth to a bit depth higher than 8-bits. Although legacy JPEG is an existing standard for storing digital images, it has some drawbacks. For example, legacy JPEG does not support compression of images with higher bit depths (9 to 16 bits) into a bit-depth higher than 8-bits, such as 12-bits, and is not designed for high-dynamic-range (HDR) imaging.

The imaging system described herein can provide a system for encoding and a system for decoding an image in JPEG format. An HDR display for an image can extend a range of user experience when viewing the image. Although some HDR imaging and display systems, such as, for example, HDR10+ systems or Dolby Vision® systems, may display and capture HDR content, example embodiments of the imaging system described herein can leverage aspects of quantization steps performed as part of the JPEG standard on traditional imaging and display systems to achieve higher bit depths.

Some image formats, such as JPEG XT, can capture HDR content by applying a series of partially backwards extensions to the legacy JPEG standard. Also, for example, JPEG XT uses new inefficient codings where legacy image decoders cannot benefit from the information added in the extended format. There are other image capturing formats, such as JPEG XL, AV1 Image File Format (AVIF) with a maximum bit depth of 12, Better Portable Graphics (BPG), High Efficiency Image Format (HEIF) with a maximum bit depth of 10, among others, that are not backwards compatible with the legacy JPEG standard.

Some techniques described herein address Mach banding issues associated with 8-bit dynamics for HDR images. For example, when 8-bit dynamics are used, the appearance of banding levels may be further away from each other, and banding of adjacent steps may become more visible to a viewer of the image. In some embodiments, color banding may occur with 8-bit JPEG with a very high quality, low noise image. Color banding may be perceptible in a low dynamic range image, and when a high dynamic range is used, the color banding may be aggravated. Using a larger number of bits per component, such as for example, 10 bits or more, may reduce or eliminate color banding.

Accordingly, there is a need for an imaging system that enables legacy encoders and decoders to process HDR images with a higher bit depth. For example, an 8-bit captured image may be encoded as a 12-bit image. Also, for example, existing techniques enable a 14-bit image to be compressed to 8-bits. However, as described herein, the 14-bit image may be maintained as a source image, and encoded as a 12-bit image, while maintaining at least some of the information included in the 14-bit format. Also, for example, a decoded image may be in an 8-bit format, a 10-bit format, a 12-bit format, and so forth.

Also, for example, an image can be decoded and displayed in HDR format. For example, an 8-bit image can be decoded and displayed in 12-bit format. In examples described herein, one or more quantization steps of the JPEG standard may be removed. Also, for example, frame buffers and intermediate image results may be modeled based on higher bit depth values, and in some instances, by utilizing floating points. Modifications to color space conversion may also be implemented, for example, in accordance with an International Color Consortium (ICC) profile. Beneficially, when an ICC profile for HDR uses a look-up table (LUT), the values in the LUT may be interpolated to reduce quantization errors.

### II. Example Devices

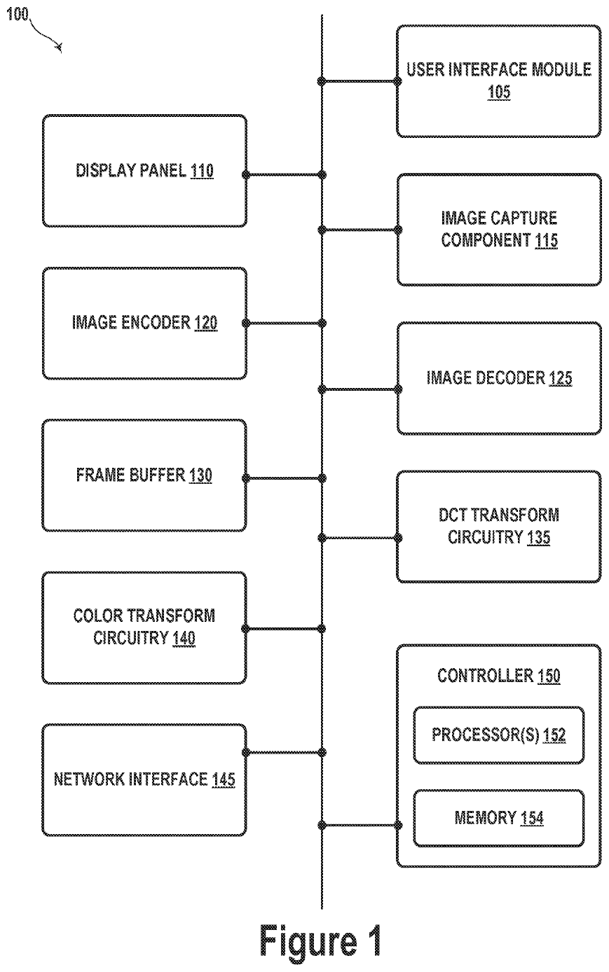

FIG. 1 illustrates computing device 100, in accordance with example embodiments. Computing device 100 includes user interface module 105, display panel 110, image capture component 115, image encoder 120, image decoder 125, frame buffer 130, DCT transform circuitry 135, color transform circuitry 140, network interface 145, and controller 150. In some examples, computing device 100 may take the form of a desktop device, a server device, or a mobile device.

User interface module 105 can be operable to send data to and/or receive data from external user input/output devices. For example, user interface module 105 can be configured to send and/or receive data to and/or from user input devices such as a touch screen, a computer mouse, a keyboard, a keypad, a touch pad, a trackball, a joystick, a voice recognition module, and/or other similar devices. User interface module 801 can also be configured to provide output to user display devices, such as display panel 110. In some examples, user interface module 105 can be used to provide a graphical user interface (GUI) for utilizing computing device 100.

Display panel 110 may be configured to provide output signals to a user by way of one or more screens (including touch screens), cathode ray tubes (CRTs), liquid crystal displays (LCDs), light emitting diodes (LEDs), organic LEDs (OLEDs), displays using digital light processing (DLP) technology, printers, light bulbs, and/or other similar technologies, either now known or later developed. Display panel 110 may also be configured to generate audible outputs, such as with a speaker, speaker jack, audio output port, audio output device, earphones, and/or other similar devices. Display panel 110 may further be configured with one or more haptic components that can generate haptic outputs, such as vibrations and/or other outputs detectable by touch and/or physical contact with computing device 100.

In example embodiments, display panel 110 is configured to be a color display utilizing a plurality of color channels for generating images. For example, display panel 110 may utilize red, green, and blue (RGB) color channels, or cyan, magenta, yellow, and black (CMYK) color channels, among other possibilities. In some embodiments, display panel 110 is configured to adjust gamma characteristics for each of the color channels of display panel 110. Also, for example, display panel 110 may be configured to adjust color characteristics for each of the color channels of display panel 110.

In some embodiments, display panel 110 may include a plurality of pixels disposed in a pixel array defining a plurality of rows and columns. For example, if display panel 110 had a resolution of 1024×600, each column of the array may include 600 pixels and each row of the array may include 1024 groups of pixels, with each group including a red, blue, and green pixel, thus totaling 3072 pixels per row. In example embodiments, the color of a particular pixel may depend on a color filter that is disposed over the pixel.

In example embodiments, display panel 110 may receive image data from controller 150 and correspondingly send signals to its pixel array in order to display the image data. For example, display panel 110 may provide such image data as a display, such as an image, a background, a wallpaper, a user interface, one or more virtual objects, scrolling, a video, a home screen, a lock screen, a menu, an application, games, and so forth. To send image data to display panel 110, controller 150 may first convert a digital image into numerical data that can be interpreted by display panel 110. For instance, a digital image may contain various image pixels that correspond to respective pixels of display panel 110. Each pixel of the digital image may have a numerical value that represents the luminance (e.g., brightness or darkness) of the digital image at a particular spot. These numerical values may be referred to as “gray levels.” The number of gray levels may depend on the number of bits used to represent the numerical values. For example, if 8 bits were used to represent a numerical value, display panel 110 may provide 256 gray levels, with a numerical value of 0 corresponding to full black and a numerical value of 255 corresponding to full white. As a more specific example, controller 150 may provide to display panel 110 a digital image stream containing 24 bits, with 8 bits corresponding to a gray level for each of the red, green, and blue color channels of a pixel group.

Image capture component 115 can include one or more image capture devices, such as still and/or video cameras, equipped to capture light and record the captured light in one or more images; that is, image capture component 115 can generate image(s) of captured light. The one or more images can be one or more still images and/or one or more images utilized in video imagery. Image capture component 115 can capture light and/or electromagnetic radiation emitted as visible light, infrared radiation, ultraviolet light, and/or as one or more other frequencies of light.

Image encoder 120 can include circuitry to perform image compression to convert an image to a compressed format, such as JPEG. For example, one or more blocks of pixels may be compressed with a compression algorithm, such as, for example, a lossy image compression algorithm such as quantized DCT coding. Image encoder 120 can include circuitry to send the compressed image to another device via a network interface, such as, for example, network interface 145. In some embodiments, image encoder 120 can include a JPEG encoder, such as a non-color managed JPEG encoder, a color managed JPEG encoder, and/a HDR encoder.

Image decoder 125 can include circuitry to perform image decompression to convert an image from a compressed format, such as JPEG, to an uncompressed format, such as bitmap. For example, one or more blocks of pixels may be decompressed with a decompression algorithm, such as, for example, baseline decoding. Image decoder 125 can include circuitry to receive the decompressed image from another device via a network interface, such as, for example, network interface 145. In some embodiments, image decoder 125 can include a JPEG decoder, such as a non-color managed JPEG decoder, a color managed JPEG decoder, and a HDR decoder.

Frame buffer 130 can be a portion of memory that can drive the display of an image or a video. In some embodiments, frame buffer 130 can be a portion of memory that can drive encoding of an image or a video. For example, frame buffer 130 can include data related to pixels in an image or a frame of a video. In some embodiments, the data can include color values for pixels in the image. In some embodiments, frame buffer 130 can include circuitry to convert an in-memory bitmap of the image to a format that can be displayed by display panel 110. In some embodiments, frame buffer 130 can include circuitry to convert an in-memory raw image to a bitmap of the image, for storage or transmission. Generally, an amount of memory in frame buffer 130 can depend on factors such as a color depth, a resolution, and so forth, for the image or video.

DCT transform circuitry 135 can include circuitry to perform a discrete cosine transform (DCT) to compress an image, and/or circuitry to perform an inverse DCT to decompress the image. Generally, the term “DCT” as used herein, can be any transformation applied in signal processing, and particularly in the processing of digital images.

Color transform circuitry 140 can include circuitry to perform a color transformation, and/or an inverse of a color transformation. For example, each pixel of an image can be associated with a vector of three values (e.g., corresponding to red, green, blue (RGB) components). Generally, each input image and output image is associated with a vector color of color components. Color components can also be described as a linear transformation of RGB, such as, for example, YUV (Y for luminance, and U, V for chrominance), CMY (for Cyan, Magenta, and Yellow), and so forth.

Network interface 150 can include one or more wireless interfaces and/or wireline interfaces that are configurable to communicate via a network. Wireless interfaces can include one or more wireless transmitters, receivers, and/or transceivers, such as a Bluetooth™ transceiver, a Zigbee® transceiver, a Wi-Fi™ transceiver, a WiMAX™ transceiver, and/or other similar types of wireless transceivers configurable to communicate via a wireless network. Wireline interfaces can include one or more wireline transmitters, receivers, and/or transceivers, such as an Ethernet transceiver, a Universal Serial Bus (USB) transceiver, or similar transceiver configurable to communicate via a twisted pair wire, a coaxial cable, a fiber-optic link, or a similar physical connection to a wireline network.

In some embodiments, network interface 150 can be configured to provide reliable, secured, and/or authenticated communications. For each communication described herein, information for facilitating reliable communications (e.g., guaranteed message delivery) can be provided, perhaps as part of a message header and/or footer (e.g., packet/message sequencing information, encapsulation headers and/or footers, size/time information, and transmission verification information such as cyclic redundancy check (CRC) and/or parity check values). Communications can be made secure (e.g., be encoded or encrypted) and/or decrypted/decoded using one or more cryptographic protocols and/or algorithms, such as, but not limited to, Data Encryption Standard (DES), Advanced Encryption Standard (AES), a Rivest-Shamir-Adelman (RSA) algorithm, a Diffie-Hellman algorithm, a secure sockets protocol such as Secure Sockets Layer (SSL) or Transport Layer Security (TLS), and/or Digital Signature Algorithm (DSA). Other cryptographic protocols and/or algorithms can be used as well or in addition to those listed herein to secure (and then decrypt/decode) communications.

Controller 150 may include one or more processor(s) 152 and memory 154. Processor(s) 152 can include one or more general purpose processors and/or one or more special purpose processors (e.g., display driver integrated circuit (DDIC), digital signal processors (DSPs), tensor processing units (TPUs), graphics processing units (GPUS), application specific integrated circuits (ASICs), etc.). Processor(s) 152 may be configured to execute computer-readable instructions that are contained in memory 154 and/or other instructions as described herein.

Memory 154 may include one or more non-transitory computer-readable storage media that can be read and/or accessed by processor(s) 152. The one or more non-transitory computer-readable storage media can include volatile and/or non-volatile storage components, such as optical, magnetic, organic, or other memory or disc storage, which can be integrated in whole or in part with at least one of processor(s) 152. In some examples, memory 154 can be implemented using a single physical device (e.g., one optical, magnetic, organic or other memory or disc storage unit), while in other examples, memory 154 can be implemented using two or more physical devices. In some embodiments, memory 154 can include frame buffer 130.

In example embodiments, processor(s) 152 are configured to execute instructions stored in memory 154 to carry out operations.

The operations may include receiving, in a frame buffer (e.g., frame buffer 130) of a computing device (e.g., computing device 100), an image captured by an image capturing device (e.g., image capture component 115) of the computing device (e.g., computing device 100). The image may include a first number of bits, for example, 8, 10, 12, 14, 16, and so forth. In some embodiments, an 8-bit frame in a JPEG format may be split and decoded into 8-bit frame buffers. However, if the decoding is to a 16-bit frame buffer, then certain aspects of the encoding phase may be revealed. For example, the encoding steps may have affected coefficients during the encoding phase. For example, when large cells are mapped to the same value, and pixels are quantized to a value of 120, then the large cell is likely to have 4 bits added to it and be based on a value that would be 64×120. The next value after 120 would be 121, and that would correspond to a value of 64×121. Thus, an 8×8 block would be reduced to 12-bits during encoding. Accordingly, the last four bits of the 12-bits would always be zero in flat areas, and the 8-bit quantization would map into the 12-bit signal. This would indicate that the encoding was not performed efficiently, and in the process, any benefit of the greater bit-depth would be lost. In some embodiments, the frame buffer may be associated with an image processing application, such as, for example, a web browsing application.

For example, basic images encoded in the JPEG1 format are described as 8-bit images in their respective specification. However, the DC coefficients (that have zero frequency in both dimensions) are encoding with 12 bits. The AC coefficients (the remaining 63 coefficients with non-zero frequencies) are 11 bits and sign. Accordingly. if every coefficient were to be rounded with an error, the resulting total error may be 64*0.5, i.e. 32, which corresponds to 5 bits of lost precision. This leads to the total worst case precision to be either 12-5, i.e., 7 bits, or for AC, 11-5, i.e., 6 bits. In practice more bits can be recovered during compression. For example, around 10 or 10.5 bits may be recovered.

Generally, a frame buffer (e.g., frame buffer 130) may be stored in two different ways. In some embodiments, the pixel colors may be interleaved. For example, the pixel colors may be in a configuration with a red pixel, then a green pixel, then a blue pixel, and a repeat of the red, green, and blue pattern, in scan line order, until the end of the image. Such a configuration may cover the first row of the image first, then the second row, and so forth, until the last row. In some embodiments, a frame buffer may be stored in a manner where the planes are separated. For example, the red pixels, the green pixels, and the blue pixels may be contiguous, and cover the image in its entirety. A choice for a particular type of storage for the frame buffer may be based on how a central processing unit (CPU), such as, for example, processor(s) 152, may process an image. In some embodiments, the frame buffer may have a size greater than 8 bits. In some embodiments, the frame buffer may be an 8-, or 9-bit frame buffer.

In some embodiments, the frame buffer may be a 32-bit floating point image buffer. Such an implementation may result in higher speeds in encoding and decoding. Generally, the resulting speed may surpass speeds for modern formats such as JPEG XL or AVIF. In some embodiments, this may allow for more practical deployments of HDR onto legacy hardware, and/or on CPU-constrained backend devices. A frame buffer with a 32-bit floating point image buffer may relate to 8 bit datatypes, such as unsigned integer 8 bits. In some embodiments, there may be 16 bits or floats like floating point values. In situations that involve floating point values, a discretization step may become moot. Also, for example, in situations that involve 16 bits, errors may be limited to within a very small epsilon neighborhood.

Generally, floating point image buffers can be implemented when the CPU is configured to handle floating points, such as, for example, on desktop computers. However, on mobile devices, the CPUs are less likely to be configured to handle floating points, and in such situations, the same computation may be performed with 16 bit integers.

The operations may further include applying, based on the first number of bits, a linear transform to the received image, wherein the linear transform comprises: (i) a color transform, and (ii) a discrete cosine transform (DCT), to generate a frequency spectrum comprising one or more frequency components. For example, controller 150 may cause color transform circuitry 140 to perform a color transform. Also, for example, controller 150 may cause DCT transform circuitry 135 to perform a discrete cosine transform (DCT). The color transform may be a transformation of the 8-bit image to an 8-bit or 16-bit image.

In some embodiments, an application of DCT in a JPEG format results in a transformation of a 64-dimensional space in a manner such that in a presence of independent errors in a correctional vector point, one or more random variables may be added with associated weights into a final signal. Generally, during compression, a maximum allowable error may be half of a unit step (e.g., an integral quantization). Accordingly, with 64 unit steps, the maximum allowable error is a 32, and this may be mapped to 5 bits. However, in practice, a maximum error is generally not achieved. For example, all errors would need to have the same sign, and such an occurrence corresponds to 1 in 263, making it a rare event. Indeed, in practice, the error may be very small. The JPEG standard sets the maximum error at half of the allowable maximum error of 32, for example, at 16. According, 4 bits may be allocated to additional precision. In some embodiments, in an 8-bit JPEG format, the coefficients may be coded with 12 bits, thus allowing for 4 bits to be allocated to additional precision. In some embodiments, the DCT transform may be applied first, and followed by the color transforms. In some embodiments, the color transform may be applied prior to the DCT transform.

In some embodiments, a chromacity plane may include a u-plane and a v-plane, and the operations may include performing a subsampling of the chromacity plane by subsampling the u-plane only. In some embodiments, a subsampling of chromacity planes may be performed between the applying of the DCT transform and the color transform. Generally, image processing may involve subsampling, such as YUV 420 subsampling, for u- and v-channels. In some embodiments, image processing may involve a higher saturation and a higher dynamic range. For example, for a bit depth greater than 8-bits, the u-plane may be subsampled, and not the v-plane. This may result in colors that are less vivid. However, such changes are less perceptible in the u-channel. For example, changes in yellow and blue colors, managed by the u-channel, are less perceptible than changes in red and green colors managed by the v-channel.

The operations may also include quantizing respective amplitudes of the one or more frequency components. In some embodiments, the quantizing may include selecting a quantization matrix compatible with HDR, particularly for the low frequency values. Choosing a quantization step of 1 enables 12 bits of dynamics for the portions of the image with slower gradient. In some embodiments, the quantization matrix may be compatible with one or more low frequency values of the HDR. In some embodiments, the quantization matrix may include 8×8 DCT coefficient arrays. The quantization matrix may be designed to provide more resolution to more perceivable frequency components over less perceivable components (e.g., lower frequencies over higher frequencies), in addition to transforming as many components to 0, which may be encoded with greater efficiency.

As described herein, a number of quantization steps to be applied may be configured to reduce error in the one or more frequency components. In some embodiments, perceptible color banding in the image may also be reduced. The elements in the quantization matrix may control a compression ratio, with larger values producing higher compression. A typical quantization matrix (for a quality of 50% as specified in the original JPEG Standard), is as follows:

$$[ \begin{matrix}16 & 11 & 10 & 16 & 24 & 40 & 51 & 61 \\ 12 & 12 & 14 & 19 & 26 & 58 & 60 & 55 \\ 14 & 13 & 16 & 24 & 40 & 57 & 69 & 56 \\ 14 & 17 & 22 & 29 & 51 & 87 & 80 & 62 \\ 18 & 22 & 37 & 56 & 68 & 109 & 103 & 77 \\ 24 & 35 & 55 & 64 & 81 & 104 & 113 & 92 \\ 49 & 64 & 78 & 87 & 103 & 121 & 120 & 101 \\ 72 & 92 & 95 & 98 & 112 & 100 & 103 & 99\end{matrix} ] \qquad ( Eqn . 1 )$$

In some embodiments, an entry in a first row and a first column of the quantization matrix is an integer value D in a range from 1 to 7.

$$[ \begin{matrix}D & 11 & 10 & 16 & 24 & 40 & 51 & 61 \\ 12 & 12 & 14 & 19 & 26 & 58 & 60 & 55 \\ 14 & 13 & 16 & 24 & 40 & 57 & 69 & 56 \\ 14 & 17 & 22 & 29 & 51 & 87 & 80 & 62 \\ 18 & 22 & 37 & 56 & 68 & 109 & 103 & 77 \\ 24 & 35 & 55 & 64 & 81 & 104 & 113 & 92 \\ 49 & 64 & 78 & 87 & 103 & 121 & 120 & 101 \\ 72 & 92 & 95 & 98 & 112 & 100 & 103 & 99\end{matrix} ] \qquad ( Eqn . 2 )$$

The top-left corner entry of the matrix is the DC coefficient (also called the constant component), and defines the basic hue for the entire 8×8 block. The remaining 63 coefficients are the AC coefficients (also called the alternating components). An advantage of DCT is a tendency to aggregate a substantial portion of the signal in one corner of the result. In some embodiments, the subsequent quantization step may accentuate this effect while simultaneously reducing the overall size of the DCT coefficients, resulting in a signal that may be easier to compress efficiently in an entropy stage. For example, JPEG may utilize run-length encoding (RLE) for zeros. RLE is a form of lossless data compression for sequences that include multiple occurrences of a value. For example, the value “0” may occur multiple times. Accordingly, the sequence can be encoded to store the value once, thereby enabling a more efficient compression process.

In some embodiments, the value in the top-left corner entry may be 1. Increasing the value to 2 may result in a loss of one of the bits. Generally, in a high dynamic range image, it may be preferable to maintain the top-left corner entry to be small so that bits may be preserved for additional precision. In some embodiments, the quantization matrix may be modified as:

$$[ \begin{matrix}D & {A}_{1} & 10 & 16 & 24 & 40 & 51 & 61 \\ {A}_{2} & {A}_{3} & 14 & 19 & 26 & 58 & 60 & 55 \\ 14 & 13 & 16 & 24 & 40 & 57 & 69 & 56 \\ 14 & 17 & 22 & 29 & 51 & 87 & 80 & 62 \\ 18 & 22 & 37 & 56 & 68 & 109 & 103 & 77 \\ 24 & 35 & 55 & 64 & 81 & 104 & 113 & 92 \\ 49 & 64 & 78 & 87 & 103 & 121 & 120 & 101 \\ 72 & 92 & 95 & 98 & 112 & 100 & 103 & 99\end{matrix} ] \qquad ( Eqn . 3 )$$

where values for A₁, A₂, A₃ may range from 1 to 7. For example, the quantization matrix may be determined as follows, based on D=A₁=A₂=A₃=1:

$$[ \begin{matrix}1 & 1 & 10 & 16 & 24 & 40 & 51 & 61 \\ 1 & 1 & 14 & 19 & 26 & 58 & 60 & 55 \\ 14 & 13 & 16 & 24 & 40 & 57 & 69 & 56 \\ 14 & 17 & 22 & 29 & 51 & 87 & 80 & 62 \\ 18 & 22 & 37 & 56 & 68 & 109 & 103 & 77 \\ 24 & 35 & 55 & 64 & 81 & 104 & 113 & 92 \\ 49 & 64 & 78 & 87 & 103 & 121 & 120 & 101 \\ 72 & 92 & 95 & 98 & 112 & 100 & 103 & 99\end{matrix} ] \qquad ( Eqn . 4 )$$

Generally, precision may not impact noisy areas; however, precision may be of great significance in portions of the image with slow gradient. For example, when there is a slow gradient in a signal, many of the components may be mapped to zeros. In these portions of slow gradient, original coefficients are set to zero. Accordingly, during quantization, no more error may be added than if the components for these portions were to be treated as random variables. In portions where the gradient is flat, 12 bit accuracy may be achieved. In portions where the gradient is small (e.g., the gradient has a small slope), 10 bit accuracy may be achieved. In some embodiments, a large number of coefficients may be allocated for active portions of an image. However, when the image block is highly active, variations in image characteristics are generally not easily discernible by a human eye. On the contrary, simpler or low active portions of an image, such as portions with slow movements, variations in image characteristics are generally discernible by the human eye.

For example, issues such as color banding may become perceptible. Generally, color banding may result from an additional discretization step performed during quantization. For example, in an image that includes a depiction of a flat region (e.g., the sky), color banding may cause new edges to emerge within the flat region. As another example, color banding may involve red-green banding in dark areas (e.g., due to psycho-visual causes). Generally, when color conversion involves a small number of colors (e.g., 8-bit color), then color banding is likely to occur.

Color profiles such as ICC profiles may sometimes be defined by using 8-bit lookup tables including 256 values. As the techniques described herein are based on a bit-depth greater than 8, the 256 values may not suffice. Accordingly, as described herein, such lookup tables may need to be interpolated in the high-bit-depth use. In some embodiments, the interpolation method may be a linear interpolation method, a quadratic interpolation method, or another method that produces additional continuous values between the values in the lookup table (e.g., more than the 256 values provided by the ICC profile). As described herein, this additional discretization step may be removed. Also, for example, more bits (e.g., 10.5 bits) may be used for frame buffers. As a result, an 8-bit JPEG is being compressed with additional information related to the image. This also solves the color banding issue.

The operations may additionally include generating, by an image processor and based on the quantizing, a compressed image comprising a second number of bits, N, wherein the second number of bits is larger than a bit capacity for compression associated with the image processor. In some embodiments, the first number of bits, M=8, and the second number of bits, N=12. Careful computation and data modeling may enable compression with additional information, thereby extending the limitations of the original design of a JPEG encoding. As these techniques may be applied to all images, existing and new JPEG images can be updated to HDR processing.

Generally, quantization errors accumulate, and when inverse DCT is applied during decoding, quantization errors are added together. In some embodiments, an average of quantization errors may be zero; however, an average of absolute values of quantization errors may accumulate, for example, like an accumulation of uniform random variables that results in a Gaussian distribution. In some embodiments, the value of sigma may increase gradually upon an addition of more errors. In such situations, a quantization error for quantizing a high frequency may be close to zero, and may therefore be discretized to zero.

Generally, reducing a number of intermediate quantization steps may improve image quality, and an 8-bit JPEG may therefore be rendered with a bit less error. In JPEG formalism, a certain number of errors appear at encoding time, and a certain number of errors appear at decoding time. Accordingly, by reducing a number of intermediate quantization steps, fewer errors appear at decoding time, thereby increasing image precision of existing signals. In some embodiments, by performing the modeling more precisely, a quantization to 8-bits with half a bit of quantization error, may result in observable changes in image quality. Also, for example, more bits become available for JPEG XL. For example, in situations where a JPEG image is stored as JPEG XL losslessly, and then decoded into pixels based on the techniques described herein, the resulting image may appear to be of higher quality.

In some embodiments, the generating of the compressed image may include performing one of a non-color managed compression, a color managed compression, or a HDR compression.

As described, processor(s) 152 are configured to execute instructions stored in memory 154 to carry out operations.

The operations may include receiving, in a frame buffer of a computing device, an image captured by an image capturing device of the computing device, wherein the image comprises a first number of bits. In some embodiments, the first number of bits, M=8. In some embodiments, the image may have been captured by a camera with high bit-depth, and M=14. In some embodiments, the compressed image may have been generated based on the techniques described herein, and M=12.

The operations may further include dequantizing respective amplitudes of one or more frequency components, wherein the dequantizing is based on an inverse of a quantization matrix compatible with a high dynamic range (HDR) image format, and wherein a number of dequantization steps to be applied is configured to reduce error in the one or more frequency components. For example, the quantization matrix may be provided as in Eqns. 2-4. In some embodiments, the dequantizing may be based on a quantization matrix compatible with one or more low frequency values of HDR.

The operations may also include applying, based on the first number of bits, an inverse linear transform to the received image, wherein the inverse linear transform comprises: (i) an inverse color transform, and (ii) an inverse discrete cosine transform (DCT).

The operations may also include generating, by an image processor and based on the applying of the inverse linear transform, a decompressed image comprising a second number of bits, wherein the second number of bits is larger than a bit capacity for compression associated with the image processor.

The operations may additionally include providing the decompressed image via a display panel of the computing device. In some embodiments, a decoder of the computing device may be configured to perform non-color managed decompression, and the operations may further include interpreting the JPEG formatted image as a YUV image. The operations may also include applying color space conversion that is hard-coded for stock JPEG images. For example, the display device may be a legacy JPEG decoder without any color management. Such a decoder may interpret the image as a YUV image, and may apply base color space conversion that may be hard coded for stock JPEG images.

In some embodiments, a decoder of the computing device may be configured to perform HDR decompression, and the operations may further include detecting one or more of: (i) a hybrid log gamma (HLG) color curve, or (ii) metadata indicating a maximum luminosity for the image. For example, the decoder may be configured with an HLG color curve. Accordingly, there may be additional metadata that specifies a maximum intensity, or a range of intensity, in an image. For example, the metadata may indicate that the image has a maximum intensity of 1000 nits or 2700 nits. In some embodiments, the image may have been stored in a manner whereby a small amount of the high brightness luminance values may be using values for the high nits values. As a result, the same HDR image can be viewed with a new device, and be interpreted as an HDR image with color management, but with low dynamic range.

In some embodiments, a decoder of the computing device may be configured to perform color managed decompression. For example, the decoder may be color managed, and may be configured to read an ICC profile that may be inside the JPEG image, and may interpret the image based on the ICC profile. In some embodiments, the ICC profile may limit a preview of an image when the image is loading. In some embodiments, an image may be displayed as a top nail, and the top nail may not be color managed, and may therefore appear with incorrect colors. However, when the top nail of the image is selected, the displayed image may be color managed, and display colors correctly.

HDR imaging is an extension of the ICC profile management. In some embodiments, HDR imaging may be achieved by means of a Perceptual Quantizer (PQ), which may generally refer to a new ‘gamma’ or transfer function for HDR. A PQ may use the human eye as a perceptual basis for its signal-to-light relationship. For this reason, PQ may be highly efficient from very low to very high light levels, and may be utilized for encoding HDR images. In some embodiments, HDR imaging may be achieved by means of HLG.

In some embodiments, the ICC profile may include look-up tables (LUTs) for color management. Unless the LUTs are continuous, they may introduce a new source of quantization. In an 8-bit JPEG, a look-up table may be configured to consider 256 possible values to look from. However, for bit depth larger than 8, values in the look-up table may be interpolated. For example, piecewise linear or cubic interpolation may be applied.

In some embodiments, display panel 110 may include circuitry configured to apply luminance profiles and the color profiles. For example, a memory may store one or more look-up tables as described herein. The values in each lookup table may be determined based upon the transmittance sensitivities of display panel 110 over a range of input gray levels.

In some embodiments, display panel 110 may include a plurality of color channels. A default gamma value may include respective register values for the plurality of color channels. In such embodiments, the plurality of color channels may include red, green, and blue (RGB) color channels.

In some embodiments, the operations may further include applying a tone mapping to the decompressed image prior to the providing of the decompressed image. For example, tone mapping may be applied to an HDR image that is to be displayed in a medium with a limited dynamic range. In some embodiments, a global and/or local tone mapping may be applied to a decompressed image prior to display. Tonemapping is a set of procedures that include mapping the pixel values according to a pre-determined function. Thus, for instance, Some camera devices map pixel values from a linear space (wherein an increase or decrease of k units in pixel value represents a proportional increase or decrease in brightness) to a non-linear space. Tonemapping may be automatically performed for artistic purposes, such as brightening mid-range pixel values. Regardless, in order to reverse tonemap the selected pixels back to linear space, the inverse of the tonemapping function may be applied to the respective pixel values.

### III. Example Image Encoding and Decoding

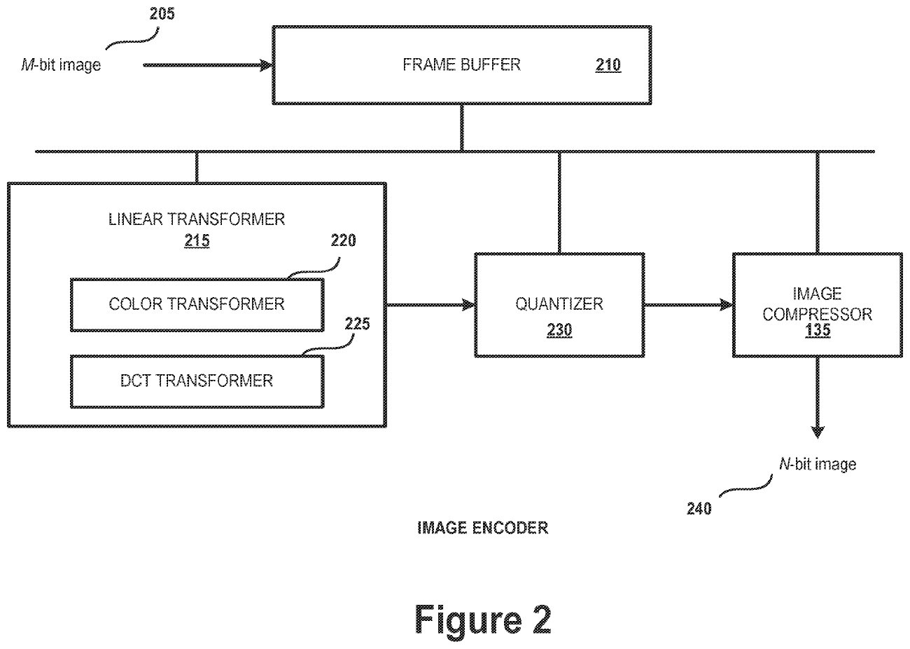

FIG. 2 illustrates an example image encoder, in accordance with example embodiments. For example, image 205 may be received. Image 205 may be an image captured by an image capturing device of the computing device, and include a first number of bits (e.g., an M-bit image). In some embodiments, the camera may be a part of a computing device (e.g., a mobile device). Frame buffer 210 may store image 205 for processing. In some embodiments, frame buffer 210 may be configured to have capacity for bit depth larger than M (e.g., M=8 and frame buffer 210 has a capacity for 12-bits). In some embodiments, frame buffer 210 may be configured to have capacity for bit depth smaller than M (e.g., M=14 and frame buffer 210 has a capacity for 12-bits). In some embodiments, frame buffer 210 may be configured to have capacity to process floating points.

Linear transformer 215 may apply a linear transform to image 205 to generate a frequency spectrum comprising one or more frequency components. For example, linear transformer 215 may include color transformer 220 to apply a color transform, and a DCT transformer 225 to apply a DCT transform. In some embodiments, color transformer 220 may apply the color transform prior to DCT transformer 225 applying the DCT transform.

Quantizer 230 may apply a quantization matrix, similar to those described in Eqns. 2-4. For example, quantizer 230 may quantize respective amplitudes of the one or more frequency components, wherein a number of quantization steps to be applied is configured to reduce error in the one or more frequency components. Image compressor 135 may generate, based on the quantizing, a compressed image including a second number of bits, such as in N-bit format. In some embodiments, N is greater than M, such as, for example, M=8, and N=12. In some embodiments, N is smaller than M, such as, for example, M=14, and N=12.

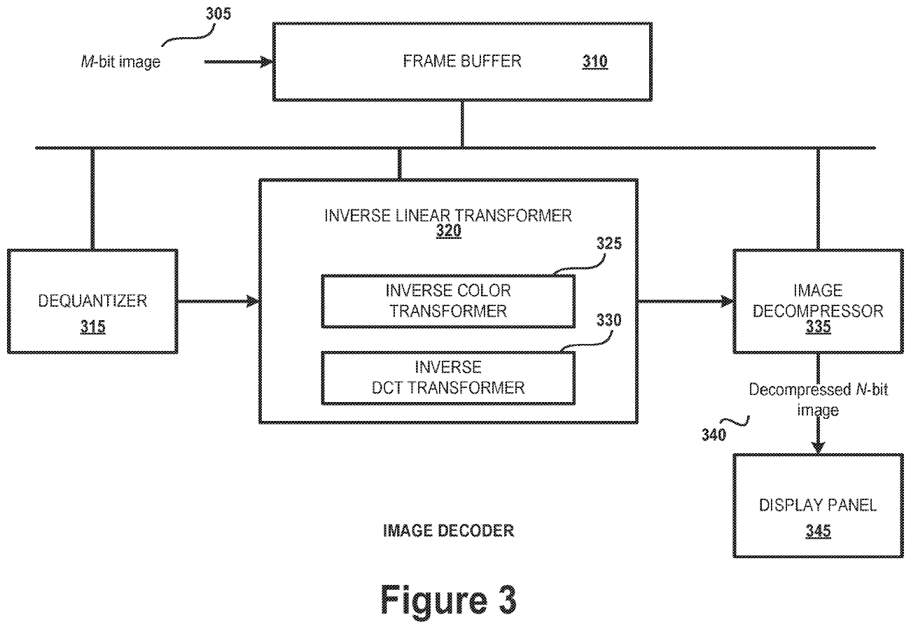

FIG. 3 illustrates an example image decoder, in accordance with example embodiments. An image 305 may be received, where image 305 is a compressed image with a first number of bits, M.

Frame buffer 310 may store image 305 for processing. In some embodiments, frame buffer 310 may be configured to have capacity for bit depth larger than M. In some embodiments, frame buffer 310 may be configured to have capacity to process floating points.

Dequantizer 315 may dequantizing respective amplitudes of one or more frequency components, wherein the dequantizing is based on an inverse of a quantization matrix compatible with a high dynamic range (HDR) image format, and wherein a number of dequantization steps to be applied is configured to reduce error in the one or more frequency components. For example, the quantization matrix may be similar to those described in Eqns. 2-4.

Inverse linear transformer 320 may apply an inverse of a linear transform applied to image 305 at encoding. For example, inverse linear transformer 320 may include inverse color transformer 325 to apply an inverse color transform, and an inverse DCT transformer 330 to apply an inverse DCT transform.

Image decompressor 335 may decompress image 305 to generate decompressed image 340 in N-bit format. In some embodiments, N is greater than M, such as, for example, M=8, and N=12. In some embodiments, N is smaller than M, such as, for example, M=14, and N=12.

Decompressed image 340 may be provided to display panel 345. In some embodiments, a global and/or local tone mapping may be applied to decompressed image 340 prior to display by display panel 345.

### IV. Example Compression Methods

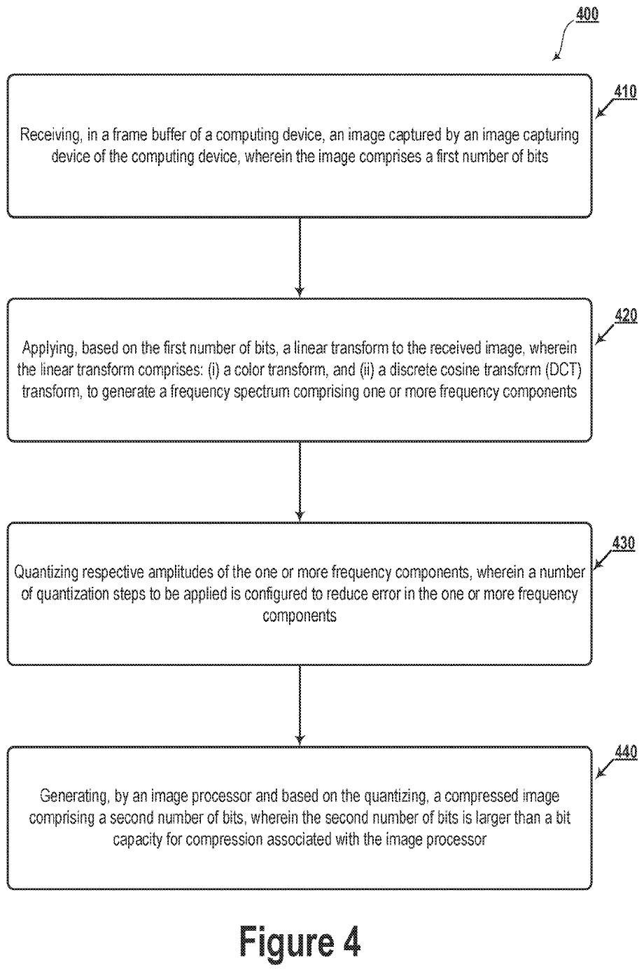

FIG. 4 illustrates an image compression method, in accordance with example embodiments. Method 400 may include various blocks or steps. The blocks or steps may be carried out individually or in combination. The blocks or steps may be carried out in any order and/or in series or in parallel. Further, blocks or steps may be omitted or added to method 400.

The blocks of method 400 may be carried out by various elements of computing device 100 as illustrated and described in reference to FIG. 1. Furthermore, method 400 may utilize the relationships that are illustrated and described with regard to FIGS. 2 and 3.

Block 410 includes receiving, in a frame buffer of a computing device, an image captured by an image capturing device of the computing device, wherein the image comprises a first number of bits.

Block 420 includes applying, based on the first number of bits, a linear transform to the received image, wherein the linear transform comprises: (i) a color transform, and (ii) a discrete cosine transform (DCT), to generate a frequency spectrum comprising one or more frequency components.

Block 430 includes quantizing respective amplitudes of the one or more frequency components, wherein a number of quantization steps to be applied is configured to reduce error in the one or more frequency components.

Block 440 includes generating, by an image processor and based on the quantizing, a compressed image comprising a second number of bits, wherein the second number of bits is larger than a bit capacity for compression associated with the image processor.

In some embodiments, the frame buffer may have a size greater than M bits.

In some embodiments, the frame buffer may be a 32-bit floating point image buffer.

In some embodiments, the quantizing may include selecting a quantization matrix compatible with a high dynamic range (HDR) image format. In some embodiments, the quantization matrix may be compatible with one or more low frequency values of the HDR image format. In some embodiments, the quantization matrix may include 8×8 DCT coefficient arrays. In some embodiments, an entry in a first row and a first column of the quantization matrix is an integer value in a range from 1 to 7.

In some embodiments, the generating of the compressed image may include performing one of a non-color managed compression, a color managed compression, or a high dynamic range (HDR) compression.

In some embodiments, the frame buffer may be associated with a web browsing application.

In some embodiments, the color transform may be applied prior to the DCT transform.

In some embodiments, a chromacity plane may include a u-plane and a v-plane, and the method may include performing a subsampling of the chromacity plane by subsampling the u-plane only.

### V. Example Decompression Methods

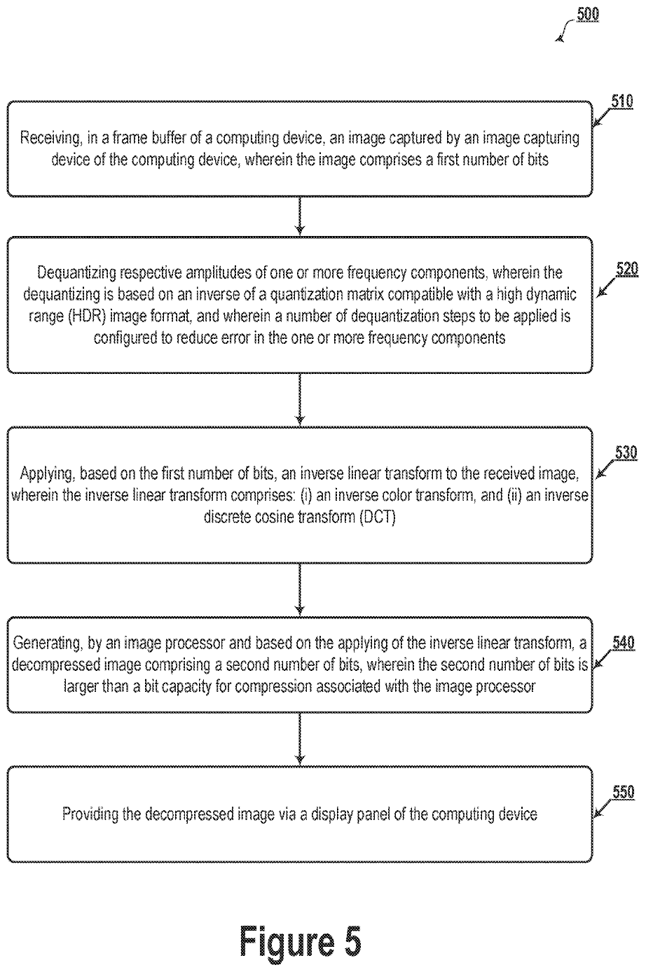

FIG. 5 illustrates a method 500, in accordance with example embodiments. Method 500 may include various blocks or steps. The blocks or steps may be carried out individually or in combination. The blocks or steps may be carried out in any order and/or in series or in parallel. Further, blocks or steps may be omitted or added to method 500.

The blocks of method 500 may be carried out by various elements of computing device 100 as illustrated and described in reference to FIG. 1. Furthermore, method 500 may utilize the relationships that are illustrated and described with regard to FIGS. 2 and 3.

Block 510 includes receiving, in a frame buffer of a computing device, an image captured by an image capturing device of the computing device, wherein the image comprises a first number of bits.

Block 520 includes dequantizing respective amplitudes of one or more frequency components, wherein the dequantizing is based on an inverse of a quantization matrix compatible with a high dynamic range (HDR) image format, and wherein a number of dequantization steps to be applied is configured to reduce error in the one or more frequency components.

Block 530 includes applying, based on the first number of bits, an inverse linear transform to the received image, wherein the inverse linear transform comprises: (i) an inverse color transform, and (ii) an inverse discrete cosine transform (DCT).

Block 540 includes generating, by an image processor and based on the applying of the inverse linear transform, a decompressed image comprising a second number of bits, wherein the second number of bits is larger than a bit capacity for compression associated with the image processor.

Block 550 includes providing the decompressed image via a display panel of the computing device.

In some embodiments, the frame buffer may have a size greater than M bits.

In some embodiments, the frame buffer may be a 32-bit floating point image buffer.

In some embodiments, the dequantizing may be based on a quantization matrix compatible with one or more low frequency values of HDR.

In some embodiments, the quantization matrix may include 8×8 DCT coefficient arrays.

In some embodiments, an entry in a first row and a first column of the quantization matrix is an integer value in a range from 1 to 7.

In some embodiments, a decoder of the computing device may be configured to perform non-color managed decompression, the received image may be a Joint Photographic Experts Group (JPEG) formatted image, and the method may further include interpreting the JPEG formatted image as a YUV image. The method may also include applying color space conversion that is hard-coded for stock JPEG images.

In some embodiments, a decoder of the computing device may be configured to perform color managed decompression.

In some embodiments, a decoder of the computing device may be configured to perform HDR decompression, and the method may further include detecting one or more of: (i) a hybrid log gamma (HLG) color curve, or (ii) metadata indicating a maximum luminosity for the image.

In some embodiments, the frame buffer may be associated with a web browsing application.

In some embodiments, the method may further include applying a tone mapping to the decompressed image prior to the providing of the decompressed image.

The particular arrangements shown in the Figures should not be viewed as limiting. It should be understood that other embodiments may include more or less of each element shown in a given Figure. Further, some of the illustrated elements may be combined or omitted. Yet further, an illustrative embodiment may include elements that are not illustrated in the Figures.

A step or block that represents a processing of information can correspond to circuitry that can be configured to perform the specific logical functions of a herein-described method or technique. Alternatively or additionally, a step or block that represents a processing of information can correspond to a module, a segment, or a portion of program code (including related data). The program code can include one or more instructions executable by a processor for implementing specific logical functions or actions in the method or technique. The program code and/or related data can be stored on any type of computer readable medium such as a storage device including a disk, hard drive, or other storage medium.

The computer readable medium can also include non-transitory computer readable media such as computer-readable media that store data for short periods of time like register memory, processor cache, and random access memory (RAM). The computer readable media can also include non-transitory computer readable media that store program code and/or data for longer periods. Thus, the computer readable media may include secondary or persistent long-term storage, like read only memory (ROM), optical or magnetic disks, compact disc read only memory (CD-ROM), for example. The computer readable media can also be any other volatile or non-volatile storage systems. A computer readable medium can be considered a computer readable storage medium, for example, or a tangible storage device.

While various examples and embodiments have been disclosed, other examples and embodiments will be apparent to those skilled in the art. The various disclosed examples and embodiments are for purposes of illustration and are not intended to be limiting, with the true scope being indicated by the following claims.

1. A computer-implemented image compression method, comprising:
receiving, in a frame buffer of a computing device, an image captured by an image capturing device of the computing device, wherein the image comprises a first number of bits;
applying, based on the first number of bits, a linear transform to the received image, wherein the linear transform comprises: (i) a color transform, and (ii) a discrete cosine transform (DCT), to generate a frequency spectrum comprising one or more frequency components;
quantizing respective amplitudes of the one or more frequency components, wherein a number of quantization steps to be applied is configured to reduce error in the one or more frequency components; and
generating, by an image processor and based on the quantizing, a compressed image comprising a second number of bits, wherein the second number of bits is larger than a bit capacity for compression associated with the image processor.

2. The computer-implemented method of claim 1, wherein the frame buffer has a size greater than the first number of bits.

3. The computer-implemented method of claim 1, wherein the frame buffer is a 32-bit floating point image buffer.

4. The computer-implemented method of claim 1, wherein the quantizing comprises selecting a quantization matrix compatible with a high dynamic range (HDR) image format.

5. The computer-implemented method of claim 4, wherein the quantization matrix is compatible with one or more low frequency values of the HDR image format.

6. The computer-implemented method of claim 4, wherein the quantization matrix comprises 8×8 DCT coefficient arrays.

7. The computer-implemented method of claim 4, wherein an entry in a first row and a first column of the quantization matrix is an integer value in a range from 1 to 7.

8. The computer-implemented method of claim 1, wherein the generating of the compressed image comprises performing one of a non-color managed compression, a color managed compression, or a high dynamic range (HDR) compression.

9. The computer-implemented method of claim 1, wherein the frame buffer is associated with a web browsing application.

10. The computer-implemented method of claim 1, wherein the color transform is applied prior to the DCT transform.

11. The computer-implemented method of claim 1, wherein a chromacity plane comprises a u-plane and a v-plane, and the method further comprises:
performing a subsampling of the chromacity plane by subsampling the u-plane only.

12. A computer-implemented image decompression method, comprising:
receiving, in a frame buffer of a computing device, an image captured by an image capturing device of the computing device, wherein the image comprises a first number of bits;
dequantizing respective amplitudes of one or more frequency components, wherein the dequantizing is based on an inverse of a quantization matrix compatible with a high dynamic range (HDR) image format, and wherein a number of dequantization steps to be applied is configured to reduce error in the one or more frequency components;
applying, based on the first number of bits, an inverse linear transform to the received image, wherein the inverse linear transform comprises: (i) an inverse color transform, and (ii) an inverse discrete cosine transform (DCT);
generating, by an image processor and based on the applying of the inverse linear transform, a decompressed image comprising a second number of bits, wherein the second number of bits is larger than a bit capacity for compression associated with the image processor; and
providing the decompressed image via a display panel of the computing device.

13. The computer-implemented method of claim 12, wherein the frame buffer has a size greater than the first number of bits.

14. The computer-implemented method of claim 12, wherein the frame buffer is a 32-bit floating point image buffer.

15. The computer-implemented method of claim 12, wherein the quantization matrix is compatible with one or more low frequency values of the HDR image format.

16. The computer-implemented method of claim 12, wherein the quantization matrix comprises 8×8 DCT coefficient arrays.

17. The computer-implemented method of claim 12, wherein an entry in the first row and first column of the quantization matrix is an integer value in a range from 1 to 7.

18. The computer-implemented method of claim 12, wherein a decoder of the computing device is configured to perform non-color managed decompression, wherein the received image is a Joint Photographic Experts Group (JPEG) formatted image, and the method further comprises:
interpreting the JPEG formatted image as a YUV image; and
applying color space conversion that is hard-coded for stock JPEG images.

19. The computer-implemented method of claim 12, wherein a decoder of the computing device is configured to perform color managed decompression.

20. The computer-implemented method of claim 12, wherein a decoder of the computing device is configured to perform HDR decompression, and the method further comprises:
detecting one or more of: (i) a hybrid log gamma (HLG) color curve, or (ii) metadata indicating a maximum luminosity for the image.

21. The computer-implemented method of claim 12, wherein the frame buffer is associated with a web browsing application.

22. The computer-implemented method of claim 12, further comprising:
applying a tone mapping to the decompressed image prior to the providing of the decompressed image.

23. A computing device, comprising:
one or more processors; and
data storage, wherein the data storage has stored thereon computer-executable instructions that, when executed by the one or more processors, cause the computing device to carry out functions comprising:
receiving, in a frame buffer of a computing device, an image captured by an image capturing device of the computing device, wherein the image comprises a first number of bits;
applying, based on the first number of bits, a linear transform to the received image, wherein the linear transform comprises: (i) a color transform, and (ii) a discrete cosine transform (DCT), to generate a frequency spectrum comprising one or more frequency components;
quantizing respective amplitudes of the one or more frequency components, wherein a number of quantization steps to be applied is configured to reduce error in the one or more frequency components; and
generating, by an image processor and based on the quantizing, a compressed image comprising a second number of bits, wherein the second number of bits is larger than a bit capacity for compression associated with the image processor.
